(19) United States
(12) Patent Application Publication
(10) Pub. No.: US 2025/0358006 A1
(43) Pub. Date: Nov. 20, 2025

(54) OPTICAL COMMUNICATION SYSTEM USING SPATIAL MODE MULTIPLEXING

(71) Applicant: Honeywell International Inc., Charlotte, NC (US)

(72) Inventor: Alan Scott, Arnprior (CA)

(21) Appl. No.: 18/667,734

(22) Filed: May 17, 2024

(51) Int. Cl. H04B 10/112; H04B 10/2581

(52) U.S. Cl. CPC H04B 10/1123; H04B 10/2581

(57) ABSTRACT

An optical system includes an optical transmitter coupled to a signal transmitting path, an optical receiver coupled to a signal receiving path, and a phase plate array configured to couple a first portion of an optical beam to a first single-mode fiber and to couple other portions of the optical beam to a plurality of other single-mode fibers. The first portion of the optical beam corresponds to a fundamental optical mode and the other portions corresponds to a plurality of higher-order optical modes. The first single-mode fiber is coupled to both the signal transmitting path and the signal receiving path using an optical circulator, and the plurality of other single-mode fibers are coupled to the signal receiving path.

### TECHNICAL FIELD

The present disclosure relates to optical communication systems.

### BACKGROUND

Free space optical (FSO) communication links can be established between various optical communication terminals. For example, FSO links can occur between one or more satellites (i.e., inter-satellite FSO links), between satellites and ground-terminals, as well as between different ground-terminals.

### SUMMARY

In general, the disclosure describes systems, devices, and methods for FSO communication links. In some examples, the systems, devices, and methods may be used between two communication terminals that may be separated by long distances and for which a full duplex transmit and receive (Tx/Rx) communication link is to be established and maintained using an electromagnetic (e.g., optical) signal.

In accordance with the systems, devices, and methods disclosed herein, a system may be configured to be co-linear between communication terminals without moving parts for beam steering (e.g., actuated pointing mechanisms) and with an increased numerical aperture for higher signal throughput, e.g., relative to systems that couple to single-mode fibers. In some examples, the system includes a multi-mode fiber in a transmit-receive optical path and a phase plate array configured to decouple the multiple modes of an optical beam exiting the multi-mode fiber to a fundamental optical mode of the optical beam and to a plurality of higher-order optical modes.

In one example, an optical system includes: an optical transmitter coupled to a signal transmitting path; an optical receiver coupled to a signal receiving path; and a phase plate array configured to couple a first portion of an optical beam to a first single-mode fiber and to couple other portions of the optical beam to a plurality of other single-mode fibers, wherein the first portion of the optical beam corresponds to a fundamental optical mode and the other portions corresponds to a plurality of higher-order optical modes, wherein the first single-mode fiber is coupled to both the signal transmitting path and the signal receiving path using an optical circulator, wherein the plurality of other single-mode fibers are coupled to the signal receiving path.

In another example, a method includes: coupling, by a phase plate array, a fundamental optical mode of an optical beam to a first single-mode fiber; and coupling, by the phase plate array, a plurality of higher-order optical modes of the optical beam to a plurality of other single-mode fibers, wherein the first single-mode fiber is coupled to a signal transmitting path coupled to an optical transmitter, wherein the plurality of other single-mode fibers are coupled to a signal receiving path coupled to an optical receiver.

In another example, an optical system includes: an optical transmitter coupled to a signal transmitting path; an optical receiver coupled to a signal receiving path; a phase plate array configured to couple a fundamental optical mode of an optical beam to a first single-mode fiber and to couple a plurality of higher-order optical modes of the optical beam to a plurality of other single-mode fibers, wherein the first single-mode fiber is coupled to the signal transmitting path, wherein the plurality of other single-mode fibers are coupled to the signal receiving path; a plurality of intensity sensors, the plurality of sensors configured to detect a fundamental optical mode intensity coupled to the first single-mode fiber and a plurality of higher-order optical mode intensities coupled to the plurality of other single-mode fibers; and processing circuitry configured to: cause the optical transmitter to output a transmit optical beam to the first single mode fiber; determine, based on a predetermined configuration of the transmit optical beam, one or more transmit higher-order optical modes within a multi-mode fiber to result in the predetermined configuration of the transmit optical beam exiting the multi-mode fiber; and cause the phase plate array to couple the transmit optical beam from the first single-mode fiber to the one or more transmit higher-order optical modes.

The details of one or more examples are set forth in the accompanying drawings and the description below. Other features, objects, and advantages will be apparent from the description and drawings, and from the claims.

### BRIEF DESCRIPTION OF THE FIGURES

FIG. 1 is a schematic illustration of an example environment for operating one or more free space optical (FSO) communication systems.

FIG. 2 is a simplified block diagram of an example FSO communication link, in accordance with some embodiments.

FIG. 3 is schematic illustration of a conventional free space optical communication system.

FIG. 4 is schematic illustration of an example phase plate array.

FIG. 5A is a schematic illustration of an example communication system using an example phase plate array.

FIG. 5B is a schematic illustration of transmitting optical signals via the example communication system of FIG. 5A using an example phase plate array.

FIG. 5C is a schematic illustration of receiving optical signals via the example optical communication system of FIG. 5A where an optical signal is received off-axis.

FIG. 5D is a schematic illustration of receiving optical signals via the example optical communication system of FIG. 5A where an optical signal is received on-axis.

FIG. 5E is schematic illustration of the example communication system of FIG. 5A using an example phase plate array and an example optical direction coupler.

FIG. 5F is schematic illustration of the example communication system of FIG. 5A using an example phase plate array and another example optical direction coupler.

FIGS. 6 and 7 are flow diagrams of methods of optical communication.

### DETAILED DESCRIPTION

Beam steering may be challenging to establish a duplex optical communication link between terminals separated by a relatively large distance (e.g., kilometers) which may be moving relative to each other due to the finite speed of light and sending/receiving signals via a narrow beam (e.g., substantially collimated beam) in order to output and receive large enough signals. Actuated mirrors for beam pointing as well as fine pointing (e.g., to remove small motion perturbations such as jitter of one or both terminals) may be used, but such systems may be large, costly, have a relatively large weight, and require moving parts. For example, transmit and receive beams may need to be steered on the order of microradians, for which sub-microradian precision is needed for beams having widths that are also on the order of microradians. The communication terminals may couple optical signals to optical fibers for collection and detection of the optical signals, and in order to coherently demultiplex signal information from a carrier band to a base band, the optical fibers may need to be single-mode fibers because the multiple modes of multi-mode fibers may degrade or destroy the coherence of the beam. However, single-mode fibers have relatively small numerical apertures reducing signal throughput relative to multi-mode fibers.

In accordance with the systems, devices, and methods disclosed herein, a system may be configured to be co-linear between communication terminals without moving parts for beam steering (e.g., actuated pointing mechanisms) and with an increased numerical aperture for higher signal throughput, e.g., relative to systems that couple to single-mode fibers. In some examples, the system includes a multi-mode fiber in a transmit-receive optical path and a phase plate array configured to decouple the multiple modes of an optical beam exiting the multi-mode fiber to a fundamental optical mode of the optical beam and to a plurality of higher-order optical modes.

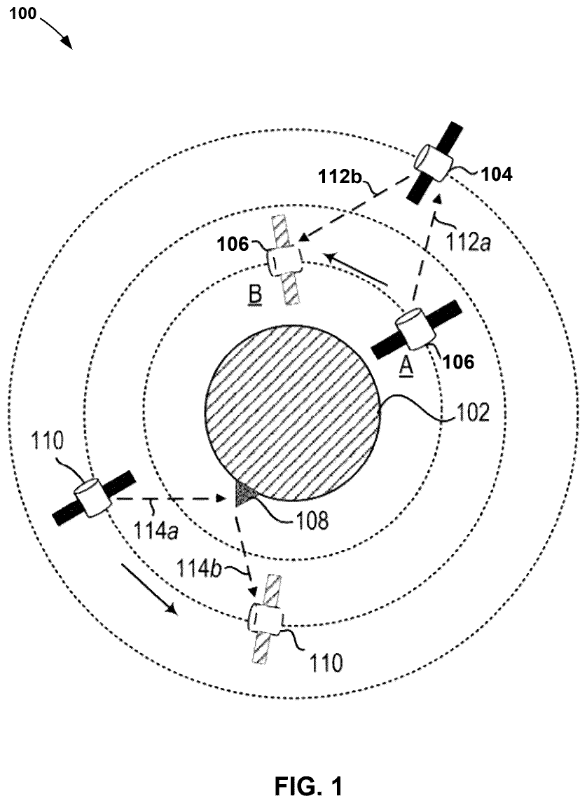

FIG. 1 is a schematic illustration of an example environment 100 for operating one or more free space optical (FSO) communication systems. FSO communication systems may be located within communication terminals installed on satellites 104, 106 orbiting a ground (e.g., earth) 102 reference, as well as on airborne vehicles (i.e., aircrafts) and various ground-based terminals 108 (e.g., mobile or stationary). The communications systems may be adapted to receive and/or transmit optical signals across free space mediums, including air mediums and/or vacuums (i.e., space). Each FSO system may include a transmitter to transmit outgoing optical signals and/or receivers to receive incoming optical signals. FSO communication links may be established between neighboring optical communication terminals to allow for exchange of data. For example, FSO links may be established between two or more satellites (i.e., inter-satellite FSO links 112a, 112b), between satellites and ground-terminals (i.e., FSO links 114a, 114b), as well as between various ground-terminals. Each FSO link may include downlinks (112a, 114a) as well as uplinks (112 b, 114 b).

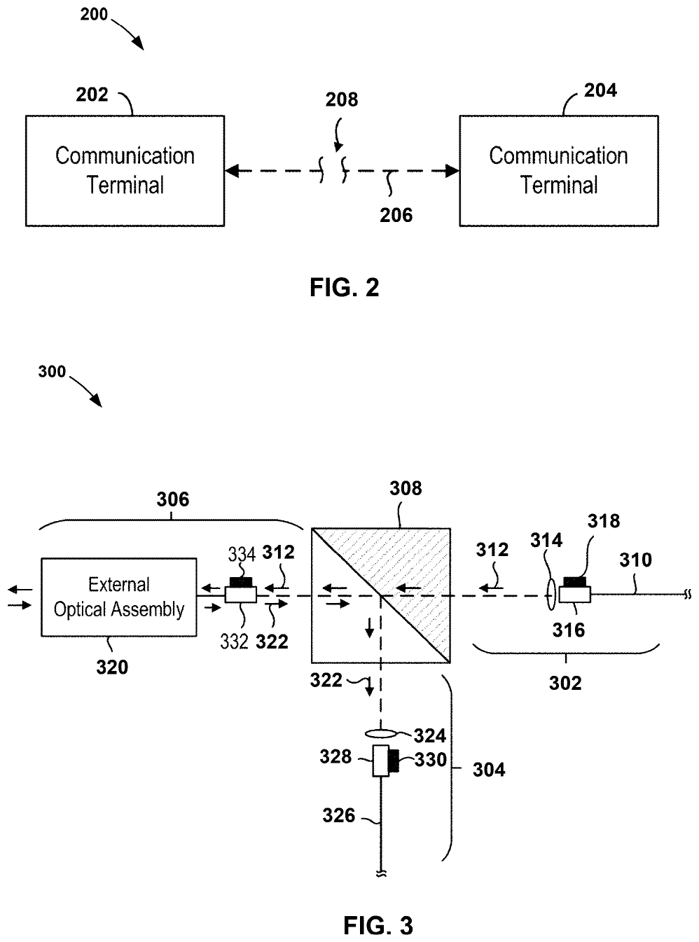

FIG. 2 is a simplified block diagram of an example FSO communication system 200. In the example shown, an FSO link 206 may be established between at least two optical communication terminals 202, 204, i.e., terminals installed on satellites, aircrafts or on ground. FSO link 206 May allow data to be exchanged between terminals 202, 204 over a free space medium 208. In some examples, a communication terminal may only transmit optical signals, receive optical signals, or may both transmit and receive optical signals (e.g., terminals 202, 204 may be transmitter terminals, receiver terminals, or transceiver terminals).

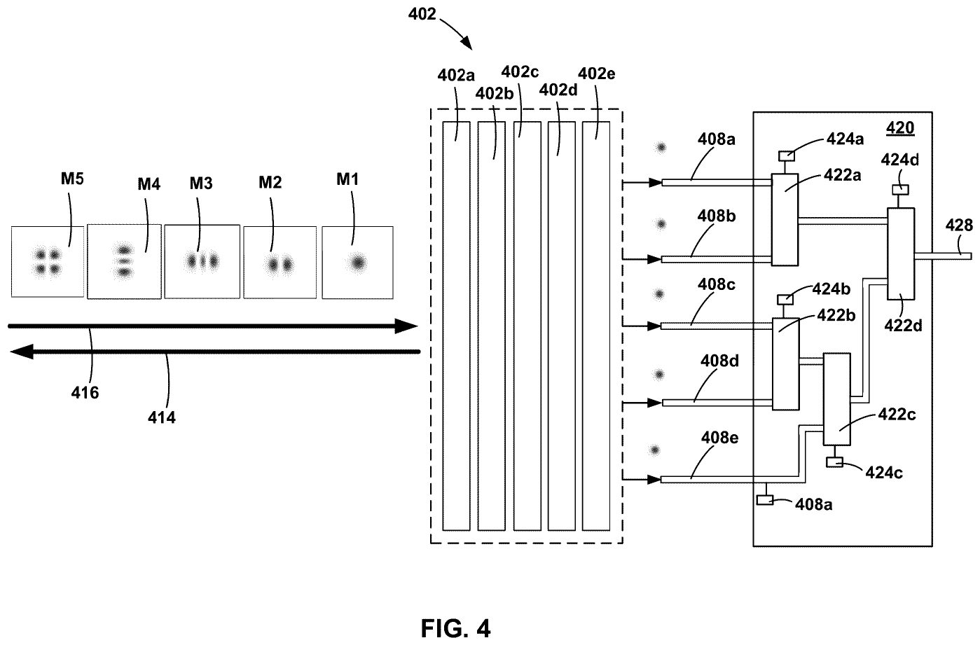

FIG. 3 is schematic illustration of a conventional FSO communication system 300. FSO communication system 300 may be located within a communication terminal, e.g., terminal 202 and/or 204. FSO communication system 300 may allow for both transmission and reception of optical signals.

As shown in FIG. 3, the FSO communication system 300 may include an optical signal transmitting pathway 302, an optical signal receiving pathway 304, and an external pathway 306. Interposed between the pathways 302, 304, 306 is a beam splitter 308. Beam splitter 308 is a dichroic mirror that splits the transmitting (Tx) pathway 302 and receiving (Rx) pathway 304 along a central wavelength. For instance, dichroic beam splitter 308 may pass outgoing optical signals having a first range of wavelengths, while reflecting incoming optical signals having a second range of wavelengths. In other cases, rather than being a dichroic mirror, the beam splitter 308 can comprise a polarizing beam splitter which separates optical signals based on their polarization. In still other cases, aperture splitting or mode splitting methods may also be used to separate the transmitting pathway 302 from the receiving pathway 304.

Transmitting pathway 302 may include a first fiber optic link or cable 310 for carrying transmitted optical signals 312, e.g., generated by an upstream transmitter, such as a laser light source. The fiber optic cable 310 may carry the optical signal 312, and transmit the optical signal 312, via an internal aperture 314, towards the beam splitter 308 (e.g., from an open end of the optical fiber 310). Transmitted optical signal 312 may be within the first range of wavelengths, or may comprise the first range of wavelengths, that passes directly through dichroic beam splitter 308. Transmitted signal 312 may then continue onwards from the beam splitter 308 to the external pathway 306. External pathway 306 may include an external optical assembly 320, which may include various mirrors, lenses, and/or other optical components or the like that may magnify the outgoing signal and/or direct the outgoing signal along a particular direction, e.g., via a coarse pointing assembly. The transmitted signal may then continue further onwards to other external communication terminals.

In the reverse case, an incoming optical signal, e.g., received from another external communication terminal, may be received along the external pathway 306 via the external optical assembly 320, e.g., as received signal 322. From the external optical assembly 320, the signal may travel towards the beam splitter 308. Received signal 322 may be within a second range of wavelengths that is reflected by beam splitter 308 towards receiving pathway 304, and away from the transmitting pathway 302. Received signal may travel through receiving pathway 304 and, via an internal aperture 324, may be received into a second fiber optic cable or link 326. The fiber optic cable 326 may carry the received signal towards various receiving modules (i.e., modules for detection, signal processing and demodulation, or the like).

As illustrated, each internal aperture 314, 324 may also include a corresponding fine pointing optical assembly 316, 328, as well as an actuator 318, 330 for controlling the respective fine pointing assembly. The fine pointing assemblies 316, 328 may couple to the respective fiber optic link 310, 326 and either, (i) receive outgoing optical signals therefrom (e.g., assembly 316), or (ii) transmit incoming optical signals thereto (e.g., assembly 328). The fine pointing assemblies 316, 328 may include, for example, fast steering mirrors and the actuators 318, 330, respectively. Actuators 318, 330 may include motors that rotate the fast-steering mirrors. In some cases, only one of the fine pointing assemblies 316, 328 and corresponding actuators 318, 330 may be provided in the system. In some cases, a fine pointing assembly 332 (and corresponding actuator 334) may also be interposed between the beam splitter 308 and the external optical assembly 320.

Fine pointing assemblies 316, 328 may be adapted to provide fine beam steering of the corresponding optical signal. For example, fine pointing assemblies may be configured to stabilize jitter, e.g., of FSO communication system 300 and/or a terminal and/or vehicle including FSO communication system 300, to maintain accurate directional beam steering notwithstanding vibrational forces causing the jitter. Fine pointing assemblies 316, 318 may also be used for point-ahead or point-behind directional offset corrections. Point-ahead and point-behind directional offset corrections compensate for non-negligible time-of-flight of optical signals when the FSO communication system 300 communicates with an external terminal having a high relative velocity (e.g., satellites 104, 106 of FIG. 1). For example, during transmission of optical signals, between the time the optical signal is transmitted by the FSO communication system 300 and the time the optical signal is received at an external terminal, the receiving terminal may have shifted its position owing to its high relative velocity (e.g., satellite 106 of FIG. 1 shifting position from position “A” to position “B”). Accordingly, the fine pointing assembly 316 may be configured to correct the outgoing direction of the outgoing optical signal to accommodate for this positional shift. In the reverse case, when an optical signal is received from an external terminal, the fine pointing assembly 328 may effect small corrective deflections to the incoming signals so as to properly route the received signal into the optical link 326.

FSO communication system 300 may have a number of disadvantages. For example, the conventional design of FSO communication system 300 requires separating the transmitting and receiving channels (e.g., transmitting channel 302 and receiving pathway 304). Each separate channel includes separate fiber coupling links 310, 326, as well as separate optical systems for each link (e.g., separate fine pointing assemblies 316, 328). Accordingly, to realize the conventional design, at least twice the system components (e.g., fine pointing assemblies and fiber optic links) and control systems (e.g., for controlling actuators 318, 330) are required to accommodate each separate channel. This, in turn, increases the mass and power consumption of the communication system. In many cases, FSO applications (e.g., satellites) require low mass and low power consumption for effective operation.

Additionally, the transmit and receive signals must have different wavelengths and/or different polarizations, e.g., to enable the beam splitter 308 to effectively separate between the transmit and receive channels. As such, techniques such as wavelength division multiplexing (WDM), which allow for increased information transfer in the transmitted or received optical signals, may not operate well with the conventional system design of FSO communication system 300.

In accordance with the systems, devices, and methods disclosed herein, a system may be configured to be co-linear between communication terminals without moving parts for beam steering (e.g., actuated pointing mechanisms) and with an increased numerical aperture for higher signal throughput, e.g., relative to systems that couple to single-mode fibers. In some examples, the system includes a multi-mode fiber in a transmit-receive optical path and a phase plate array configured to decouple the multi-modes to a fundamental optical mode of an optical beam and to a plurality of higher-order optical modes.

As used herein, modes of an optical beam are electric field distributions which are self-consistent during propagation in free-space or in a medium (e.g., within a fiber). For example, an optical beam may have one or more Hermite-Gaussian, Hermite-Laguerre, Laguerre-Gaussian, or any other orthogonal set of two-dimensional polynomial modes, e.g., with a Gaussian fundamental mode. The fundamental mode of an optical beam, e.g., from a laser source, may be the Gaussian mode, e.g., the transverse electromagnetic 00 (TEM00) mode. All other modes of the optical beam are higher-order optical modes of an optical beam and have a more complex intensity profile (e.g., an intensity profile of the light in a plane perpendicular to the direction of propagation). For a given optical frequency (e.g., wavelength of light), a waveguide has only a finite number of guided propagation modes.

The systems, device, and methods disclosed herein may provide a number of advantages. For example, systems disclosed herein may have co-linear, e.g., shared, transmitting and receiving channels and/or paths, providing reduced number of system components, reduced power consumption, size and mass, e.g., reduced size, weight, and power consumption (SWAP), and reduced complexity, e.g., reduced control systems required to control the reduced components. Additionally, systems disclosed herein may provide and/or enable improved information transfer, e.g., by not requiring the transmit and receive signals to have different wavelengths and/or different polarizations by virtue of eliminating the need to split the transmit and receive signals, thereby enabling techniques such as WDM to be used with the example systems disclosed herein.

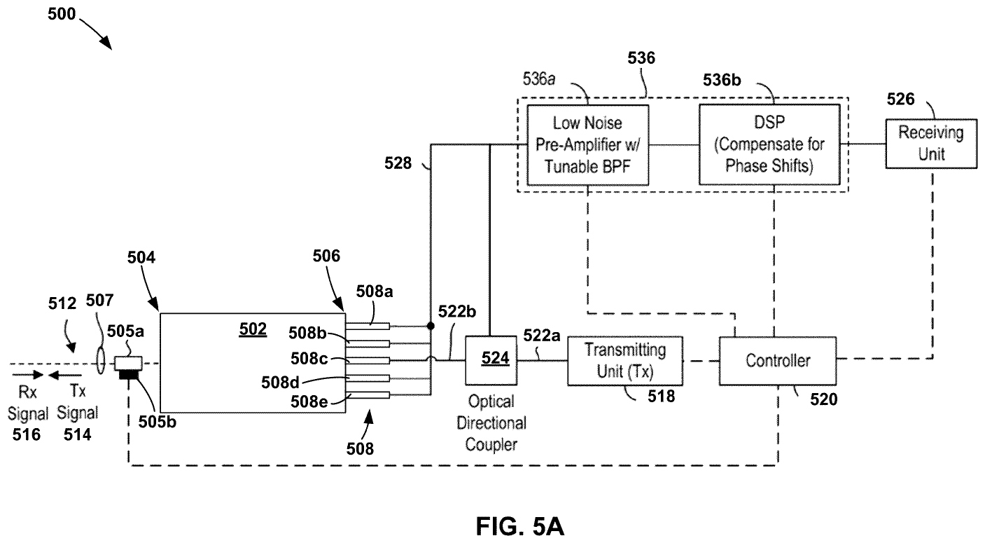

FIG. 4 is schematic illustration of an example phase plate array 402. Phase plate array 402 may be used to couple modes of received optical beam 416 into one or more single-mode fibers 408, or to couple light from one or more of single-mode fibers 408 to transmitted optical beam 414.

In some examples, received optical beam 416 may be received by an optical system and coupled to a multi-mode fiber for transport to a detection system. Received optical beam 416 may include information encoded in one or more modes of received optical beam 416, e.g., modes M1-M5. The information encoded in the one or more modes M1-M5 may need to be separated in order to be recovered, e.g., to coherently demultiplex the optical signal from a carrier band. For example, phase plate array 402 may be configured to efficiently, and/or adiabatically, couple a plurality of modes, e.g., modes M1-M5, from a multi-mode fiber of the optical system to corresponding single-mode fibers 408 for coherent demultiplexing, e.g., by a heterodyne detection system. In some examples, received optical beam 416 may include various free space optical modes (e.g., gaussian, Hermite-gaussian and Laguerre-gaussian modes) entering the multi-mode fiber of the optical system that couple to modes M1-M5.

Additionally, phase plate array 402 may be configured to enable a system to simultaneously receive and send optical signals without moving parts, e.g., without mechanically moving a mirror, shutter, lens, or the like. For example, an optical system may be configured to couple received optical beam 416 to one or more of a plurality of higher modes, e.g., M2-M5, and to direct the fundamental mode of the multi-mode fiber as transmitted optical beam 414 towards a target recipient. The received optical beam 416 and transmitted optical beam 414 may then share a co-linear optical system, e.g., a multi-mode fiber, and phase plate array 402 may be configured to couple received optical beam 416 from the multi-mode fiber to the correct single-mode fibers 408 for detection and to couple transmitted optical beam 414 from a single-mode fiber to the correct mode of the multi-mode fiber for transmission. The co-linear system may be configured to output transmitted optical beam 414 on-axis, relative to the multi-mode fiber and phase plate array 402 and receive off-axis optical signals as received optical beam 416 for detection. In other examples, the optical system may be configured to couple received optical beam 416 to any mode, e.g., including the fundamental mode, of an optical fiber, and to direct any mode, including any of the higher order optical modes of the multi-mode fiber, as transmitted optical beam 414 towards a target recipient.

In the example shown, phase plate array 402 includes a plurality of phase plates 402a-402e (collectively, “phase plate array 402”), and is configured to couple a fundamental optical mode (e.g., mode M1) of received optical beam 416 to a single-mode fiber, e.g., single-mode fiber 408c. Phase plate array 402 may also be configured to couple higher-order optical modes of received optical beam 416 (e.g., M2-M5) to a plurality of other single-mode fibers, e.g., single-mode fibers 408a, 408b, 408d, and 408e. In some examples, phase plate array 402 is configured to couple the fundamental optical mode to the first single-mode fiber 408c, and to couple the plurality of higher-order optical modes to the plurality of other single-mode fibers 408a, 408b, 408d, and 408e, adiabatically. For example, phase plate array 42 may be configured to couple a first portion of received optical beam 416 to a first single-mode fiber 408c and to couple other portions of received optical beam 416 a plurality of other single-mode fibers, e.g., single-mode fibers 408a, 408b, 408d, and 408e. The first portion of received optical beam 416 corresponds to a fundamental optical mode and the other portions corresponds to higher-order optical modes. In some examples, phase plate array 402 comprises a multi-pass cavity, and each phase plate 402a-402e may be configured to modify a phase of incident light and/or efficiently transfer the portion of optical beam energy in one optical mode into a single mode fiber.

In the example shown, each phase plate 402a-402e of phase plate array 402 is configured to separate a particular mode of the received optical beam 416, and to couple the particular mode to a single-mode fiber, e.g., as if it were a fundamental mode. For example, phase plate 402a may be configured to separate mode M2 from received optical beam 416 and couple mode M2 to single-mode fiber 408a, phase plate 402b may be configured to separate mode M3 from received optical beam 416 and couple mode M3 to single-mode fiber 408b, phase plate 402c may be configured to separate mode M1 from received optical beam 416 and couple mode M1 to single-mode fiber 408c (e.g., to couple the fundamental mode of received optical beam 416 to a central single-mode fiber 408c of the plurality of single-mode fibers 408), phase plate 402d may be configured to separate mode M4 from received optical beam 416 and couple mode M4 to single-mode fiber 408d, and phase plate 402e may be configured to separate mode M5 from received optical beam 416 and couple mode M5 to single-mode fiber 408e.

In some examples, the amount of light coupled to each single-mode fiber 408a-408e (collectively, “single-mode fibers 408”) may be indicative of a weight, or an amount, of a particular mode of received optical beam 416 received by phase plate array 406. For example, the amount of light coupled to single-mode fiber 408a may be indicative of an amount, or a weighting, of mode M5 of received optical beam 416.

Conversely, for outputting optical signals, each phase plate 402a-402e of phase plate array 402 may be configured to couple light from one or more of the single-mode fibers 408 to one or more corresponding modes M1-M5 of the transmitted optical beam 414, e.g., to one or more modes of a multi-mode fiber of an optical system configured to output a transmitted optical beam 414. For example, phase plate 402a may be configured to couple light from single-mode fiber 408a to mode M2, phase plate 402b may be configured to couple light from single-mode fiber 408b to mode M3, phase plate 402c may be configured to couple light from single-mode fiber 408c to mode M1, phase plate 402d may be configured to couple light from single-mode fiber 408d to mode M4, and phase plate 402e may be configured to couple light from single-mode fiber 408e to mode M5.

In some examples, an optical system may include a recombiner 420 configured to coherently recombine the light coupled into single-mode fibers 408 from phase plate array 402. In some examples, the recombiner may be configured to detect, or redirect for detection, an amount of light coupled to each single-mode fiber 408a-408e. For example, the recombiner may comprise a photonic integrated circuit (PIC) comprising a plurality of Mach-Zehnder phase-shifting interferometers 422a-422d configured to receive light from the plurality of single-mode fibers 408 and coherently recombine the light from each of single-mode fibers 408a-408e. An amount of light from each of the single-mode fibers 408a-408e may be detected, e.g., via the ‘out-of-phase’ Mach-Zehnder output and detectors 424a-424d, which may be included on the PIC at each Mach-Zehnder 422a-422d. In some examples, the amount of light of each of the single-mode fibers 408a-408e may be indicative of an amount of received optical beam 416 coupled into a particular mode, e.g., the amount of light detected from single-mode fiber 408a may be indicative of the amount of light of received optical beam 416 coupled to mode M2. Recombiner 420 may be configured to output coherently recombined light, e.g., via fiber 428.

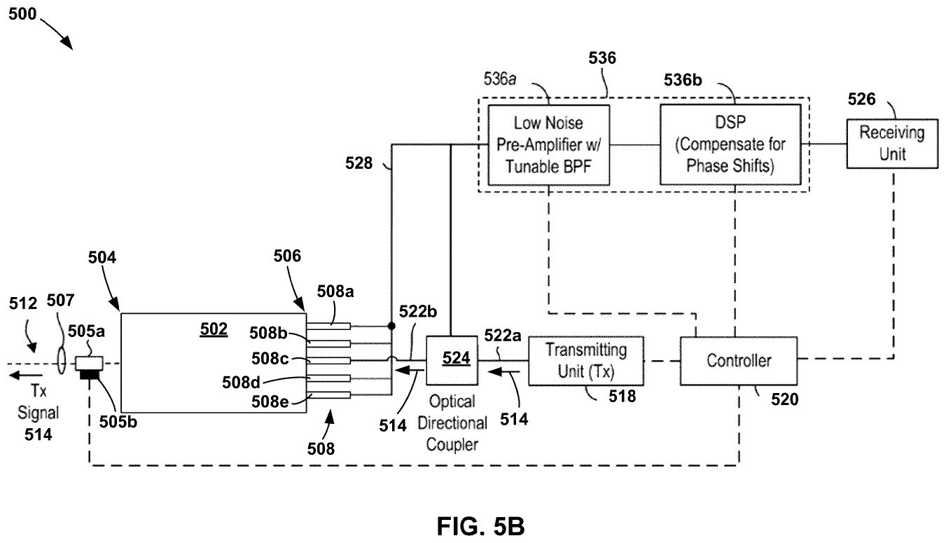

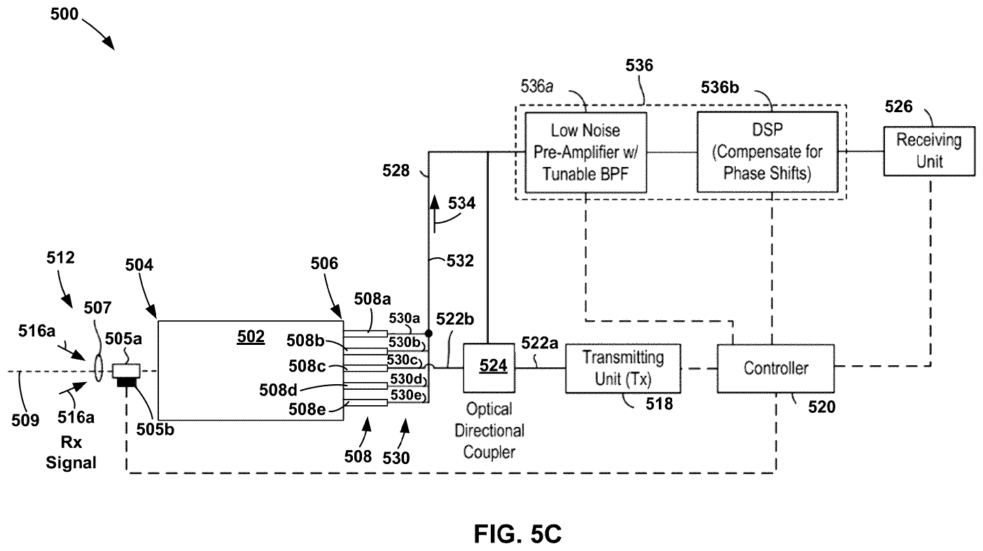

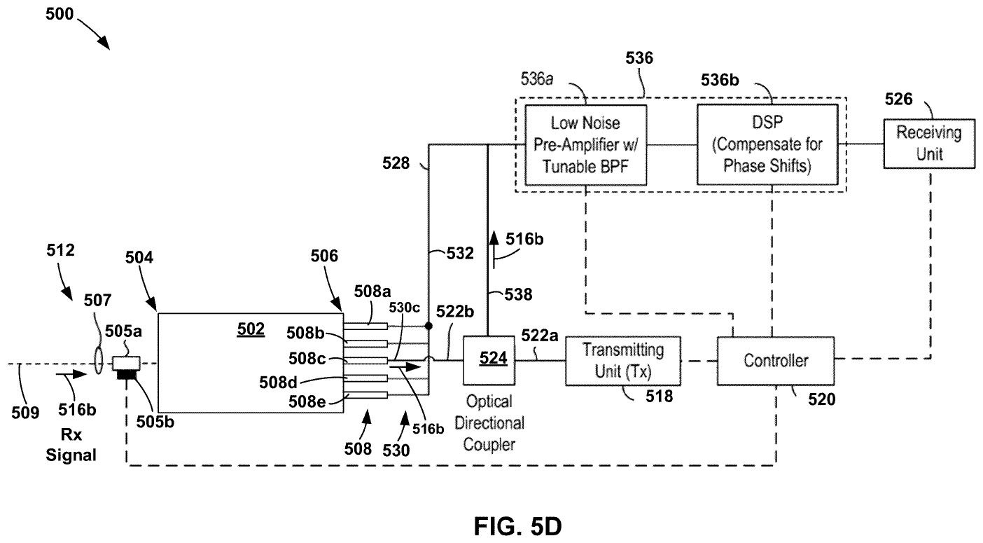

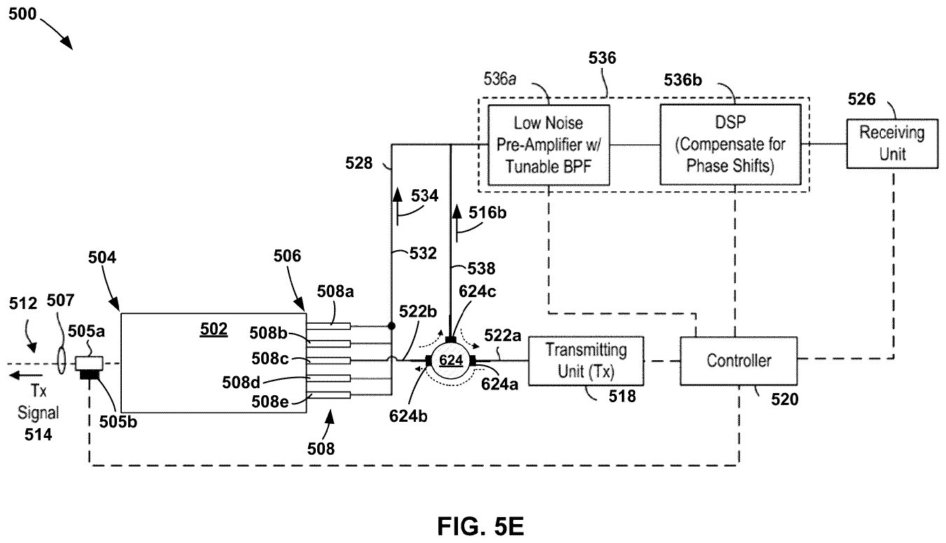

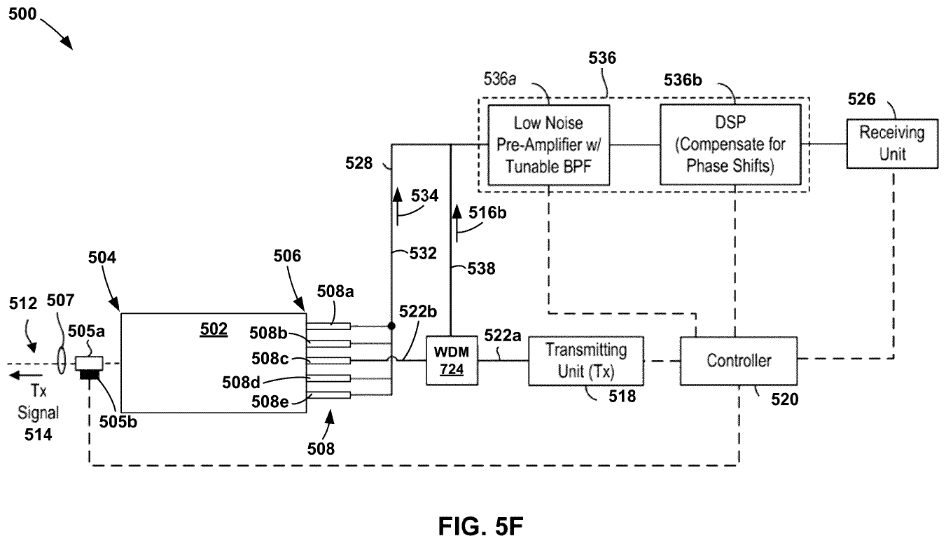

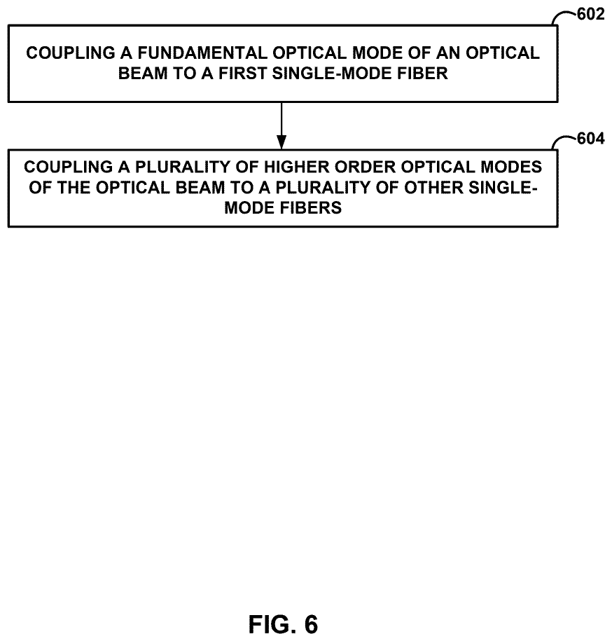

FIG. 5A is a schematic illustration of an example communication system 500 using an example phase plate array 502. Phase plate array 502 may be substantially similar to phase plate array 402.

In the example shown, phase plate array 502 includes a first end 504 and a second end 506. The first end 504 of phase plate array 502 may be coupled to an external communication path 512. For example, phase plate array 502 may be coupled to a multi-mode fiber at first end 504, and the opposite end of the multi-mode fiber may be coupled to external communication path 512. External communication path 512 may be substantially similar to external pathway 306 of FIG. 3 and may include, for example, an external optical assembly (not shown). The external optical assembly may be similar to the assembly 320 and may be used to communicate with other optical communication terminals (e.g., located on other satellites).

In some examples, a fine pointing assembly 505a and a corresponding actuator 505b may be interposed between the first end 504 of phase plate array 502 and the external communication path 512. The fine pointing assembly 505a may receive or transmit optical signals via an internal aperture 507. The actuator 505b may be controlled, for example, by a controller 520.

The remainder of the optical system 500 is described below in greater detail with reference to FIGS. 5B-5D. FIG. 5B is a schematic illustration of transmitting optical signals via communication system 500 using example phase plate array 502, FIG. 5C is a schematic illustration of receiving optical signals via communication system 500 using an example phase plate array 502, and FIG. 5D is another schematic illustration of receiving optical signals via communication system 500 using an example phase plate array 502. In the examples shown in FIGS. 5B-5D, not all elements of the optical system 500 as shown in FIG. 5A are reproduced, however it will be appreciated that these elements may still be included in the optical system 500.

Referring to FIG. 5B, optical system 500 may include a transmitting unit 518. Transmitting unit 518 may be configured to convert outgoing signals from an alternate communication and/or processing format (e.g., Ethernet) into optical signals, e.g., transmitted optical beam 514, carrying data. Transmitting unit 518 may be configured to modulate outgoing signals for transmission as an optical laser signal along a signal transmission path 522a and 522b (collectively, “signal transmission path 522”). For example, transmitting unit 518 may include a laser light source.

In some examples, transmitting unit 518 may include an external or integrated optical modulator such as an electro-absorption modulator (EAM) or a Lithium Niobate Mach Zehnder external modulator. The optical modulator may be operable to modulate the laser light source to generate an outgoing optical laser signal, e.g., transmitted optical beam 514, which is transmitted along the signal transmission path 522 to phase plate array 502. For example, the light source may be modulated such as by phase modulating the carrier optical signal (e.g., the laser beam) such that a modulated transmitted optical signal is generated which includes a sequence of multi-photon pulses with varying phase shifts, each phase shift corresponding to a unique data symbol (e.g., one or more bits of information). In some examples, the amplitude of the carrier signal may also be varied, e.g., in addition to the phase, to encode a wider array of data. Examples of phase modulation schemes, and related variants, include n-PSK (phase-shift key) modulation, quadrature phase shift keying (QPSK), dual-polarization quadrature phase shift keying (DP-QPSK), offset phase shift keying (OPSK) modulation and n-QAM (quadrature amplitude modulation). In some examples, transmitting unit 518 is coupled (e.g., electrically coupled) to controller 520. Controller 520 may include a processor with executable instructions to control operation of transmitting unit 518 (e.g., to control time of transmission, data to be modulated into carrier signal, or any suitable data, signal, and/or light transmission parameter).

Transmitted optical beam 514 generated by transmitting unit 518 may travel in an outward direction along signal transmission path 522. Signal transmission path 522 may extend between transmitting unit 518 and an opening of single-mode fiber 508c coupled to second end 506 of phase plate array 502. In some examples, the signal transmission path 522 may comprise an optical fiber cable or link. As used herein, the outward direction (e.g., outward signal direction) refers to a direction that includes a signal travel path that includes signals travelling from the second end 506 of phase plate array 502 to first end 504 of phase plate array 502, and an inward direction (e.g., inward signal direction) refers to a direction which includes a signal travel path extending from first end 504 to second end 506 of phase plate array 502.

Transmitted optical beam 514 may travel through the signal transmission path 522 and onwards through phase plate array 502, e.g., travelling from the second end 506 to the first end 504 of phase plate array 502. For example, transmitting unit 518 may generate the optical signal as a fundamental mode, e.g., an optical signal coupled to single-mode fiber 508c for which phase plate array 502 is configured to couple the optical signal to the fundamental mode of a multi-mode fiber at first end 504. In the example shown, transmitted optical beam 514 may exit phase plate array 502 along communication path 512, e.g., via a multi-mode fiber, and may be directed by the fine pointing assembly 505a to accommodate for point ahead or point behind offsets.

In some examples, signal transmission path 522 may be interposed by an optical directional coupler 524. The optical directional coupler 524 may segment the signal transmission path 522 into a first transmission path portion 522a and a second transmission path portion 522b. The first transmission path portion 522a extends between the transmitting unit 518 and the optical directional coupler 524, and the second transmission path portion 522b extends between the optical directional coupler 524 and single-mode fiber 508c at the second lantern end 506. The operation of the optical directional coupler 524 is explained in greater detail herein with reference to FIGS. 5E and 5F.

Referring to FIG. 5C, received optical beam 516a may be subject to a point ahead or point behind offset, and may be received off-axis. For example, a communication terminal, e.g., communication terminal 202 and/or communication terminal 204 of FIG. 2, may include optical system 500. Received optical beam 516a may be received at an offset angle corresponding to the point ahead or point behind angle as between the transmitting optical terminal (e.g., communication terminal 204 of FIG. 2 operating as a transmitting terminal) and the receiving optical terminal (e.g., communication terminal 202 of FIG. 2 including optical system 500 and operating as a receiving terminal). When received optical beam 516a is received off-axis, the wavefront tilt can be represented (e.g., appear, or manifest) as a linear combination of individual modes. For example, the angled reception of received optical beam 516a may “distort” the optical beam at the receiving optical terminal such that received optical beam 516a may be characterized by one or more higher order optical modes that may or may not exclude the fundamental optical mode, e.g., and may be coupled to one or more higher order optical modes of a multi-mode fiber at first end 504. In FIG. 5C, the reception of off-axis optical signals is illustrated by arrows that are angled away from a central axis 509 that runs through a radial center (or otherwise, a center point) of first end 504 of phase plate array 502.

Phase plate array 502 may be configured to receive the received optical beam 516a including higher order optical modes and to couple each higher order optical mode to a corresponding single-mode fiber 508a, 508b, 508d, or 508e as if each higher order optical mode is a fundamental mode of the corresponding single-mode fibers 508a, 508b, 508d, or 508e. For example, phase plate array 502 is configured to enable the received higher-order optical modes of the off-axis received optical beam 516a to be diverted away from the transmitting unit 518, which is coupled to single-mode fiber 508c. Phase plate array 502 may be configured to adiabatically couple the higher order optical modes of received optical beam 516a to corresponding single-mode fibers 508a, 508b, 508d, or 508e exiting phase plate array 502 at second end 506 as the signal (e.g., separated and coupled modes) travels in the inward direction. In the example shown, each of the higher order optical modes of the multi-mode fiber of external communication path and coupled to phase plate array 502 at first end 504, may map to, and be coupled as fundamental, single-modes by, corresponding single-mode fibers 508a, 508b, 508d, or 508e.

At second end 506, single-mode fibers 508a, 508b, 508d, or 508e may each be coupled to a signal receiving path 528. The signal receiving path 528 may comprise, for example, one or more fiber optic links or cables that couple each of the single-mode fibers 508a, 508b, 508d, or 508e to a receiving unit 526 (e.g., coupled to the openings of single-mode fibers 508a, 508b, 508d, or 508e).

In the example shown, optical receiving path 528 may include a first receiving path portion 530 and a second receiving path portion 532. The first receiving path portion 530 may include multiple paths, e.g., 530a, 530b, 530d, and 530e, that connect to each respective opening of each single-mode fibers 508a, 508b, 508d, or 508e (also referred to herein as mode-specific receiving paths 530, or mode-specific paths 530). Each mode-specific path 530 receives a corresponding single-mode optical signal from the respective single-mode fibers 508a, 508b, 508d, or 508e. In some examples, the mode energy distribution of the corresponding single-mode optical signal from the respective single-mode fibers 508a, 508b, 508d, or 508e may be sampled, e.g., by one or more detectors, before the modes are combined into a single path. The plurality of mode-specific paths 530 may then be combined into a single receiving path portion 532. In some examples, the mode-specific paths 530 may be passively spliced together to combine into the single path portion 532 adapted to carry a single optical signal mode. For example, this may occur by way of known splicing techniques, such as via mechanical splicing or fusion splicing of optical links or cables corresponding to each of the mode-specific paths 530. In other examples, the mode-specific paths 530 may be combined by a recombiner such as described above with reference to FIG. 4.

Received optical beam 516a, after coherent separation and coherent recombination, may travel through receiving path portion 532 and may be referred to as combined received single-mode optical signal 534. Combined received single-mode optical signal 534 may travel through receiving path 532 to receiving unit 526.

Receiving unit 526 may be configured to convert combined received single-mode optical signal 534 into an alternate communication and/or processing format (e.g., Ethernet). The receiving unit 526 may be configured to demodulate incoming optical laser signal(s) received through signal reception path 528. In some examples, receiving unit 526 may be coupled to controller 520, which may be configured to control the operation of the receiving unit 526. In some examples, receiving unit 526 may include a heterodyne IQ (in-phase, and quadrature) demodulator photonic integrated circuit. The heterodyne IQ demodulator may include an amplified photodiode signal transducer and a local heterodyne laser source.

In some embodiments, optical system 500 may include signal processing unit 536. Signal processing unit 536 may be interposed along the signal reception path 528 (e.g., along second receiving path portion 532). Signal processing unit 536 may include one or more hardware sub-units for performing, for example, filtering, amplification, as well as for correcting for various time-varying and transmission-related errors in the received signal, e.g., received optical beam 516a, such as to allow for proper decoding and/or demodulating of signal data and/or information.

In the example shown in FIGS. 5A-5F, signal processing unit 536 includes a first sub-unit 536a configured to perform low noise pre-amplification and applying a tunable bandpass filter. In some examples, sub-unit 536a may not include a tunable bandpass filter, such as when receiving unit 526 is a heterodyne receiver. In some examples, sub-unit 536a may be a low-noise optical pre-amplifier, which may be positioned as shown, or which may be coupled to each optical fiber 508, e.g., before signals of optical fibers 508 are combined. Signal processing unit 536 may also include a second sub-unit 536b configured to perform digital signal processing (DSP) to compensate for phase shifts. In some examples, the DSP may comprise an electronic chip attached to the output of the optical receiving unit 526. Signal processing unit 536 may be implemented using any known method known in the art. In some examples, one or more components of signal processing unit 536 may be coupled to controller 520, and controller 520 may be configured to control operation and functioning of signal processing unit 536.

In some examples, phase offsets between the plurality of single-mode fibers configured to receive higher order optical modes from phase plate array 502, e.g., single-mode fibers 508a, 508b, 508d, or 508e, may be compensated either actively or passively to minimize destructive interference between captured modes (see e.g., techniques as discussed in A. Belmonte and J. Kahn, “Field Conjugation Adaptive Arrays in Free-Space Coherent Laser Communications,” in IEEE/OSA Journal of Optical Communications and Networking, vol. 3, no. 11, pp. 830-838, November 2011, doi: 10.1364/JOCN.3.000830). In some examples, wavefront tilts of received optical beam 516a due to off-axis receive angles may couple asymmetrically, e.g., to the multi-mode optical fiber of external communication path 512, resulting in a majority of the optical amplitude being coupled to (e.g., captured by) a single higher order optical mode, thus limiting destructive interference losses.

Referring to FIG. 5D, received optical beam 516b may not be subject to a point ahead or point behind offset, and may be received on-axis. The on-axis received optical beam 516b may include a single, fundamental mode, and may be coupled to single-mode fiber 508c by phase plate array 502. In FIG. 5D, the reception of on-axis optical signals are substantially parallel to central axis 509.

To prevent the received optical beam 516b from interfering with the transmitting unit 518, the optical directional coupler 524 may be positioned and configured to re-route the received optical beam 516b away from the transmitting unit 518, and back onto the signal recipient path 528 (e.g., directly, or via an intermediate signal path portion 538 comprising, for example, a fiber optic link). Accordingly, the optical directional coupler 524 may accommodate when the signal is not received off-axis. For example, the optical directional coupler 524 may be configured to transfer the fundamental mode, e.g., a TEM0,0 mode, to and/or from signal transmission path 522a and/or intermediate signal path portion 538.

FIG. 5E is a schematic illustration of the example communication system 500 of FIG. 5A using phase plate array 502 and optical circulator 624, and FIG. 5F is a schematic illustration of the example communication system 500 of FIG. 5A using phase plate array 502 and wave division multiplexer (WDM) 724. Optical circulator 624 and WDM 724 may be examples of directional couplers, e.g., directional coupler 524.

In the example shown in FIG. 5E, optical system 500 comprises optical circulator 624. As shown, optical circulator 624 may include a plurality of ports, e.g., ports 624a, 624b, 624c. Port 624a may be coupled to the transmitting unit 518 via the first signal transmission path portion 522a, port 624b may be coupled to the opening of the single-mode fiber to which phase plate array 502 is configured to couple the fundamental mode, e.g., single-mode fiber 508c, at second end 506 via the second signal transmission path portion 522b, and port 624c may be coupled to the receiving unit 526 via receiving path 528 (e.g., port 624c may couple to receiving path 528 either directly, or via intermediate path portion 538 which may be passively spliced into the receiving path 528).

Within the optical circulator 624, first port 624a may be internally coupled to the second port 624b such that transmitted signals, e.g., from the transmitting unit 518, are forwarded toward single-mode fiber 508c coupled to the second transmission path portion 522b. The second port 624b may further be internally coupled to the third port 624c such that incoming on-axis received signals, e.g., from single-mode fiber 508c (FIG. 5D), are routed to the signal receiving path 528, and away from the transmitting unit 518.

In the example shown in FIG. 5F, an optical directional coupler comprises a wave division multiplexer (WDM) 724. WDM 724 may be configured to transmit (e.g., via filtering) signals emitted from the transmitting unit 518 at a first range of wavelengths, and to pass the signals from the first transmit path portion 522a to the second transmit path portion 522b, and towards single-mode fiber 508c (e.g., signals travelling in an outward direction). WDM 724 may also be configured to route on-axis received optical beam 516b having a second wavelength range along the signal receiving path 528, e.g., to pass these signals-travelling in the inward direction—from the second signal transmit path portion 522b towards the signal receiving path 528.

In some examples, optical directional couplers 524, 624, and/or 724 may be configured to couple the second signal transmitting path portion 522b to the signal receiving path 532, e.g., for on-axis received optical beam 516b travelling in the inward direction and couple the first signal transmitting path portion 522a to the second signal transmitting path portion 522b, e.g., for transmitted optical beam 514 travelling in the outward direction. In other words, optical directional couplers 524, 624, and/or 724 may be configured to couple signals travelling in two opposite directions to two different signal paths. Although described as optical circulators and WDMs, optical system 500 may include any other suitable device or mechanism that can similarly act as an optical directional coupler 524, 624, and/or 724.

The use of phase plate array 502 in the communication system 500 enables incorporating both the transmission and receiving channels into the same fiber optic assembly. For example, the transmit and receive channels may share, a single fine steering assembly (e.g., fine pointing assembly 505a), thereby eliminating the dual controls for separate fine steering assemblies as shown in the conventional design in FIG. 3. This, in turn, may allow the optical communication terminal including communication system 500 to have a simpler design with lower mass and power consumption.

In some examples, phase plate array 502 is configured to enable communication system 500 to receive optical signals and/or optical beams over a large array of angles (e.g., via point ahead or point behind offsets), thereby allowing communication system 500 to have a large field of view. Phase plate array 502 is configured to convert multi-modes received at the first end 504 into a plurality of single-mode inputs, and via passive splicing, and are combined into one single-mode input, e.g., via coherent separating and/or coherent recombination. In some examples, the use of the optical directional coupler 524, 624, and/or 724, in association with a single-mode fiber 508c that carries only a fundamental mode, mitigates cases where an optical signal is received on-axis (FIG. 5D). Referring to FIG. 5A, in some examples, communication system 500 may include external optical assembly 320, which may include a collimator (not shown) configured to collimate received optical beam 516 (or received optical beams 516a, 516b) and ensures that light from different directions of received optical beams 516 fill the entire internal aperture 507 located at the first end 504.

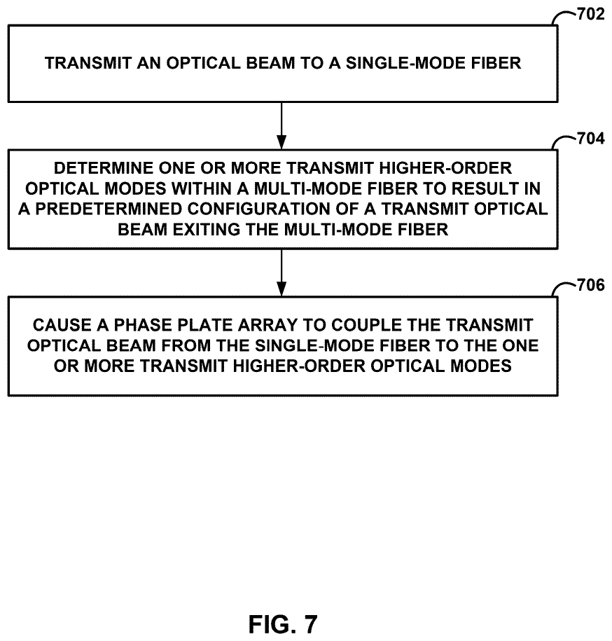

FIG. 6 is a flow diagram of a method of optical communication. Although FIG. 6 is discussed using FSO communication system 200 of FIG. 2, phase plate array 403 or FIG. 4, and communication system 500, phase plate array 502, and controller 520 of FIGS. 5A-5F, it is to be understood that the methods discussed herein may include and/or utilize other systems and methods in other examples.

A phase plate array 402 or 502 may couple a fundamental optical mode M1 of an optical beam 516 to a first single-mode fiber 508c (602). For example, an optical communication terminal 202 may include communication system 500 configured to receive a received optical beam 516 from an external signal source, e.g., another optical communication terminal 204, so as to establish a FSO communication link.

Phase plate array 402 or 502 may couple a plurality of higher-order optical modes M2-M5 of the optical beam 516 to a plurality of other single-mode fibers 508a, 508b, 508d, and 508e (602). For example, phase plate array 402 or 502 may couple higher order optical modes, e.g., M2-M5, received at first end 504 to single-mode fibers 508a, 508b, 508d, and 508e at second end 506.

FIG. 7 is a flow diagram of another method of optical communication. Although FIG. 7 is discussed using FSO communication system 200 of FIG. 2, phase plate array 403 or FIG. 4, and communication system 500, phase plate array 502, and controller 520 of FIGS. 5A-5F, it is to be understood that the methods discussed herein may include and/or utilize other systems and methods in other examples.

A controller 520 may transmit an optical beam 514 to a single-mode fiber 508c (702). For example, controller 520 may cause transmitting unit 518 to output an optical beam 514 to single mode fiber 508c. Controller 520 may cause an optical direction coupler 524, 624, and/or 724 to couple transmit optical beam 514 to single mode fiber 508c.

Controller 520 may determine, based on a predetermined configuration of the transmit optical beam 514, one or more transmit higher-order optical modes within a multi-mode fiber to result in the predetermined configuration of the transmit optical beam 514 exiting the multi-mode fiber (704). For example, controller 520 may determine an off-axis exit angle for transmit optical beam 514, e.g., a point ahead or point behind angle.

Controller 520 may cause phase plate array 502 to couple transmit optical beam 514 from single-mode fiber 508c to the one or more transmit higher order modes (e.g., M2-M5) (706). For example, controller 520 may cause phase plate array 502 to couple at least a portion of transmit optical beam 514 from single-mode fiber 508c at second end 506 to one or more higher modes M2-M5 (and optionally a portion to fundamental mode M1) of the multi-mode fiber at first end 504, which may then be emitted off-axis relative to central axis 509.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over a computer-readable medium as one or more instructions or code and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a mobile computing device, a wearable computing device, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Select examples of the present disclosure include, but are not limited to, the following examples.

Example 1: An optical system includes: an optical transmitter coupled to a signal transmitting path; an optical receiver coupled to a signal receiving path; and a phase plate array configured to couple a first portion of an optical beam to a first single-mode fiber and to couple other portions of the optical beam to a plurality of other single-mode fibers, wherein the first portion of the optical beam corresponds to a fundamental optical mode and the other portions corresponds to a plurality of higher-order optical modes, wherein the first single-mode fiber is coupled to both the signal transmitting path and the signal receiving path using an optical circulator, wherein the plurality of other single-mode fibers are coupled to the signal receiving path.

Example 2: The optical system of example 1, wherein the phase plate array is configured to couple the first portion of the optical beam to the first single-mode fiber and to couple the other portions corresponding to the plurality of higher-order optical modes to the plurality of other single-mode fibers adiabatically.

Example 3: The optical system of example 1 or example 2, wherein the fundamental optical mode of the optical beam corresponds to at least a portion of the optical beam that is received on-axis relative to the phase plate array.

Example 4: The optical system of any one of examples 1-3, wherein a higher-order optical mode of the plurality of higher-order optical modes of the optical beam corresponds to at least a portion of the optical beam that is received off-axis relative to the phase plate array.

Example 5: The optical system of any one of examples 1-4, wherein the phase plate array comprises a plurality of phase plates defining a multi-pass cavity, each phase plate configured to efficiently transfer the portion of optical beam energy in one optical mode into a single mode fiber.

Example 6: The optical system of any one of examples 1-5, wherein the signal receiving path comprises a first receiving path portion and a second receiving path portion, the first receiving path portion comprising a plurality of mode-specific paths that are coupled to each single-mode fiber of the plurality of other single-mode fibers.

Example 7: The optical system of example 6, wherein the plurality of mode-specific paths comprise optical links that are at least one of passively spliced together or combined via a photonic chip to form the second receiving path portion, the second receiving path portion also comprising an optical link.

Example 8: The optical system of any one of examples 1-7, wherein the optical system further comprises an optical directional coupler located along the signal transmitting path between the optical transmitter and an opening to the single-mode fiber connected to the phase plate, wherein the optical directional coupler is configured to transfer the TEM0,0 fundamental optical mode.

Example 9: The optical system of any one of examples 1-8, wherein the optical system further comprises a multi-mode fiber or free space beam transfer optic(s) disposed opposite the phase plate array from the first single-mode fiber and the plurality of other single-mode fibers, wherein the multi-mode fiber or beam transfer optic(s) is configured to receive the optical beam off-axis relative to the multi-mode fiber or optical axis wherein the received optical beam travels in an inward direction through the phase plate array to the first single-mode fiber and the plurality of other single-mode fibers.

Example 10: The optical system of any one of examples 1-9, further including: a plurality of intensity sensors, the plurality of sensors configured to detect a fundamental optical mode intensity coupled to the first single-mode fiber and a plurality of higher-order optical mode intensities coupled to the plurality of other single-mode fibers; and processing circuitry configured to: determine, based on the fundamental optical mode intensity and the plurality of higher-order mode intensities, a configuration of the optical beam.

Example 11: The optical system of example 10, wherein the processing circuitry is further configured to: cause the optical transmitter to output a transmit optical beam to the first single mode fiber; and cause the phase plate array to couple the transmit optical beam from the first single-mode fiber to at least one of a fundamental optical mode of the multi-mode fiber or directly to free space as a propagating Gaussian beam.

Example 12: A method includes: coupling, by a phase plate array, a fundamental optical mode of an optical beam to a first single-mode fiber; and coupling, by the phase plate array, a plurality of higher-order optical modes of the optical beam to a plurality of other single-mode fibers, wherein the first single-mode fiber is coupled to a signal transmitting path coupled to an optical transmitter, wherein the plurality of other single-mode fibers are coupled to a signal receiving path coupled to an optical receiver.

Example 13: The method of example 12, wherein coupling the fundamental optical mode and the plurality of higher-order optical modes occurs adiabatically.

Example 14: The method of example 12 or example 13, wherein the fundamental optical mode of the optical beam corresponds to at least a portion of the optical beam that is received on-axis relative to the phase plate array.

Example 15: The method of any one of examples 12-14, wherein a higher-order optical mode of the plurality of higher-order optical modes of the optical beam corresponds to at least a portion of the optical beam that is received off-axis relative to the phase plate array.

Example 16: The method of any one of examples 12-15, wherein the phase plate array comprises a plurality of phase plates defining a multi-pass cavity, each phase plate configured to efficiently transfer the portion of optical beam energy in one optical mode into a single mode fiber.

Example 17: The method of any one of examples 12-16, wherein the signal receiving path comprises a first receiving path portion and a second receiving path portion, the first receiving path portion comprising a plurality of mode-specific paths that are coupled to each single-mode fiber of the plurality of other single-mode fibers.

Example 18: An optical system includes: an optical transmitter coupled to a signal transmitting path; an optical receiver coupled to a signal receiving path; a phase plate array configured to couple a fundamental optical mode of an optical beam to a first single-mode fiber and to couple a plurality of higher-order optical modes of the optical beam to a plurality of other single-mode fibers, wherein the first single-mode fiber is coupled to the signal transmitting path, wherein the plurality of other single-mode fibers are coupled to the signal receiving path; a plurality of intensity sensors, the plurality of sensors configured to detect a fundamental optical mode intensity coupled to the first single-mode fiber and a plurality of higher-order optical mode intensities coupled to the plurality of other single-mode fibers; and processing circuitry configured to: cause the optical transmitter to output a transmit optical beam to the first single mode fiber; determine, based on a predetermined configuration of the transmit optical beam, one or more transmit higher-order optical modes within a multi-mode fiber to result in the predetermined configuration of the transmit optical beam exiting the multi-mode fiber; and cause the phase plate array to couple the transmit optical beam from the first single-mode fiber to the one or more transmit higher-order optical modes.

Various examples have been described. These and other examples are within the scope of the following claims.

What is claimed is:

1. An optical system comprising:
an optical transmitter coupled to a signal transmitting path;
an optical receiver coupled to a signal receiving path; and
a phase plate array configured to couple a first portion of an optical beam to a first single-mode fiber and to couple other portions of the optical beam to a plurality of other single-mode fibers, wherein the first portion of the optical beam corresponds to a fundamental optical mode and the other portions corresponds to a plurality of higher-order optical modes,
wherein the first single-mode fiber is coupled to both the signal transmitting path and the signal receiving path using an optical circulator,
wherein the plurality of other single-mode fibers are coupled to the signal receiving path.

2. The optical system of claim 1, wherein the phase plate array is configured to couple the first portion of the optical beam to the first single-mode fiber and to couple the other portions corresponding to the plurality of higher-order optical modes to the plurality of other single-mode fibers adiabatically.

3. The optical system of claim 1, wherein the fundamental optical mode of the optical beam corresponds to at least a portion of the optical beam that is received on-axis relative to the phase plate array.

4. The optical system of claim 1, wherein a higher-order optical mode of the plurality of higher-order optical modes of the optical beam corresponds to at least a portion of the optical beam that is received off-axis relative to the phase plate array.

5. The optical system of claim 1, wherein the phase plate array comprises a plurality of phase plates defining a multi-pass cavity, each phase plate configured to efficiently transfer the portion of optical beam energy in one optical mode into a single mode fiber.

6. The optical system of claim 1, wherein the signal receiving path comprises a first receiving path portion and a second receiving path portion, the first receiving path portion comprising a plurality of mode-specific paths that are coupled to each single-mode fiber of the plurality of other single-mode fibers.

7. The optical system of claim 6, wherein the plurality of mode-specific paths comprise optical links that are at least one of passively spliced together or combined via a photonic chip to form the second receiving path portion, the second receiving path portion also comprising an optical link.

8. The optical system of claim 1, wherein the optical system further comprises an optical directional coupler located along the signal transmitting path between the optical transmitter and an opening to the single-mode fiber connected to the phase plate, wherein the optical directional coupler is configured to transfer the TEM0,0 fundamental optical mode.

9. The optical system of claim 1, wherein the optical system further comprises a multi-mode fiber or free space beam transfer optic(s) disposed opposite the phase plate array from the first single-mode fiber and the plurality of other single-mode fibers, wherein the multi-mode fiber or beam transfer optic(s) is configured to receive the optical beam off-axis relative to the multi-mode fiber or optical axis wherein the received optical beam travels in an inward direction through the phase plate array to the first single-mode fiber and the plurality of other single-mode fibers.

10. The optical system of claim 1, further comprising:
a plurality of intensity sensors, the plurality of sensors configured to detect a fundamental optical mode intensity coupled to the first single-mode fiber and a plurality of higher-order optical mode intensities coupled to the plurality of other single-mode fibers; and
processing circuitry configured to:
determine, based on the fundamental optical mode intensity and the plurality of higher-order mode intensities, a configuration of the optical beam.

11. The optical system of claim 10, wherein the processing circuitry is further configured to:
cause the optical transmitter to output a transmit optical beam to the first single mode fiber; and
cause the phase plate array to couple the transmit optical beam from the first single-mode fiber to at least one of a fundamental optical mode of the multi-mode fiber or directly to free space as a propagating Gaussian beam.

12. A method comprising:
coupling, by a phase plate array, a fundamental optical mode of an optical beam to a first single-mode fiber; and
coupling, by the phase plate array, a plurality of higher-order optical modes of the optical beam to a plurality of other single-mode fibers,
wherein the first single-mode fiber is coupled to a signal transmitting path coupled to an optical transmitter,
wherein the plurality of other single-mode fibers are coupled to a signal receiving path coupled to an optical receiver.

13. The method of claim 12, wherein coupling the fundamental optical mode and the plurality of higher-order optical modes occurs adiabatically.

14. The method of claim 12, wherein the fundamental optical mode of the optical beam corresponds to at least a portion of the optical beam that is received on-axis relative to the phase plate array.

15. The method of claim 12, wherein a higher-order optical mode of the plurality of higher-order optical modes of the optical beam corresponds to at least a portion of the optical beam that is received off-axis relative to the phase plate array.

16. The method of claim 12, wherein the phase plate array comprises a plurality of phase plates defining a multi-pass cavity, each phase plate configured to efficiently transfer the portion of optical beam energy in one optical mode into a single mode fiber.

17. The method of claim 12, wherein the signal receiving path comprises a first receiving path portion and a second receiving path portion, the first receiving path portion comprising a plurality of mode-specific paths that are coupled to each single-mode fiber of the plurality of other single-mode fibers.

18. An optical system comprising:
an optical transmitter coupled to a signal transmitting path;
an optical receiver coupled to a signal receiving path;
a phase plate array configured to couple a fundamental optical mode of an optical beam to a first single-mode fiber and to couple a plurality of higher-order optical modes of the optical beam to a plurality of other single-mode fibers,
wherein the first single-mode fiber is coupled to the signal transmitting path,
wherein the plurality of other single-mode fibers are coupled to the signal receiving path;
a plurality of intensity sensors, the plurality of sensors configured to detect a fundamental optical mode intensity coupled to the first single-mode fiber and a plurality of higher-order optical mode intensities coupled to the plurality of other single-mode fibers; and
processing circuitry configured to:
cause the optical transmitter to output a transmit optical beam to the first single mode fiber;
determine, based on a predetermined configuration of the transmit optical beam, one or more transmit higher-order optical modes within a multi-mode fiber to result in the predetermined configuration of the transmit optical beam exiting the multi-mode fiber; and
cause the phase plate array to couple the transmit optical beam from the first single-mode fiber to the one or more transmit higher-order optical modes.
